(19) United States
(12) Patent Application Publication
(10) Pub. No.: US 2014/0032729 A1
(43) Pub. Date: Jan. 30, 2014

(54) SERVER AND METHOD TO CONNECT NETWORK DEVICE TO THE SERVER

(71) Applicants: CHUI-WEN CHIU, Tu-Cheng (TW); CHEN-LIANG LIANG, Tu-Cheng (TW); GUAN-RU CHEN, Tu-Cheng (TW)

(72) Inventors: CHUI-WEN CHIU, Tu-Cheng (TW); CHEN-LIANG LIANG, Tu-Cheng (TW); GUAN-RU CHEN, Tu-Cheng (TW)

(21) Appl. No.: 13/652,590

(22) Filed: Oct. 16, 2012

(30) Foreign Application Priority Data
Jul. 30, 2012 (TW) 101127513

(51) Int. Cl. G06F 15/173

(52) U.S. Cl. 709/223

(57) ABSTRACT

In a method to connect a server to a network device, the method generates a communication process to connect the server to a network device. The method separates an independent sub process form the communication process to connect the server to the network device, which is accompanied by an automatic end of the communication process. The method further creates a communication connection between the server and the network device.

### BACKGROUND

1. Technical Field

Embodiments of the present disclosure relate to systems and methods to manage network devices, and more particularly to a server, a storage medium, and a method to connect a network device to the server.

2. Description of related art

Servers usually use multi-process technology to connect to a plurality of network devices to manage the network devices. The server can use a communication process to simulate hypertext preprocessor (PHP) multi-process to connect one or more network devices to the server. However, the communication process carries necessary PHP modules (The PHP modules refers to logics or collections of software instructions written in the programming language PHP) to build a communication connection between the server and the network devices, and also PHP modules that are not necessary to build the communication connection between the server and the network devices, such as PHP modules for implementing dynamic web pages, which may waste a memory of the server.

### BRIEF DESCRIPTION OF THE DRAWINGS

FIG. 1 is a block diagram of one embodiment of a server including a communication connecting system.

FIG. 2 is a block diagram of one embodiment of function modules of the communication connecting system in FIG. 1.

FIG. 3 is a flowchart of one embodiment of a method to connect a network device to the server.

### DETAILED DESCRIPTION

In general, the word “module”, as used herein, refers to logic embodied in hardware or firmware, or to a collection of software instructions, written in a programming language, such as, Java, C, or assembly. One or more software instructions in the modules may be embedded in firmware, such as in an EPROM. The modules described herein may be implemented as either software and/or hardware modules and may be stored in any type of non-transitory computer-readable storage medium or other storage device. Some non-limiting examples of non-transitory computer-readable media include CDs, DVDs, BLU-RAY, flash memory, and hard disk drives.

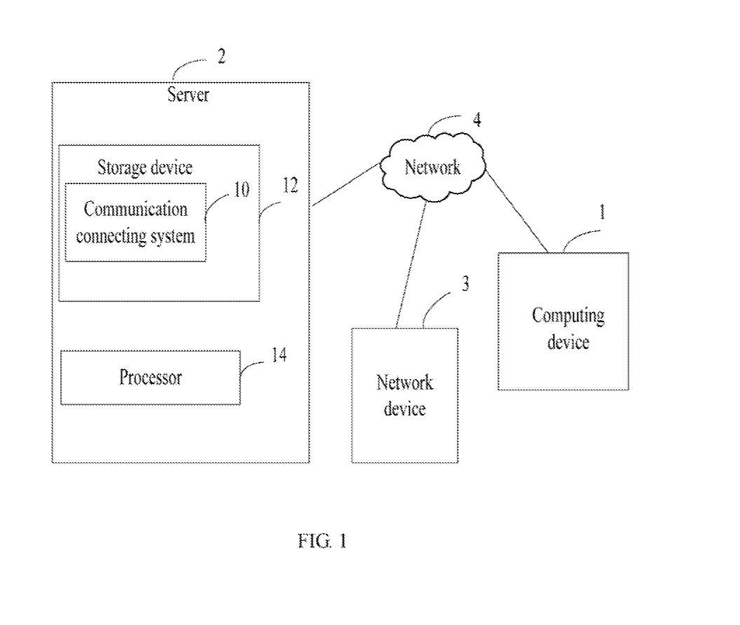

FIG. 1 is a block diagram of one embodiment of a server 1. The server 1 includes a communication connecting system 10. In the embodiment, the communication connecting system creates a communication connection between a network device 3 and the server 1, and the server 1 is connected to a computing device 2 through a network 4. The server 1 includes a storage device 12 and at least one processor 14.

The computing device 1 may be a computer or a smart phone or a tablet. On the server 2, hypertext preprocessor (PHP) multi-process is simulated to build a communication connection between the server and the network device 3 based on a communication protocol adapted to the network device 3, and the network device 3 is managed through the communication connection.

The network device 3 may be an IP camera or an IP television or other kinds of devices that can be connected to the network 4. The network 4 may be a wired network or a wireless network, such as a GPRS network.

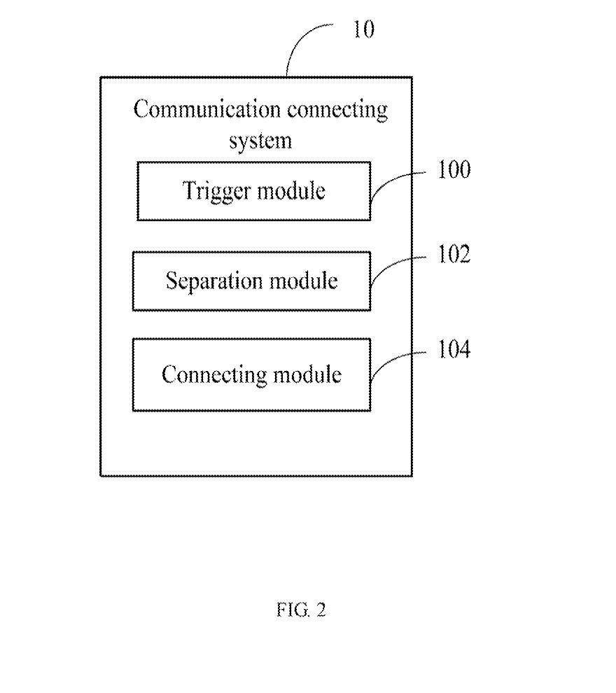

In one embodiment, the communication connecting system 10 includes a plurality of function modules (see FIG. 2 below), which include one or more programs in the form of computerized codes that are stored in the storage device 12 and executed by the processor 14.

The storage device 12 may include any type(s) of non-transitory computer-readable storage medium, such as a hard disk drive, a compact disc, a digital video disc, or a tape drive. The storage device 12 stores the computerized code of the function modules of the communication connecting system 10. The at least one processor 14 may be a processor unit, a microprocessor, an application-specific integrated circuit (ASIC), or a field programmable gate array (FPGA).

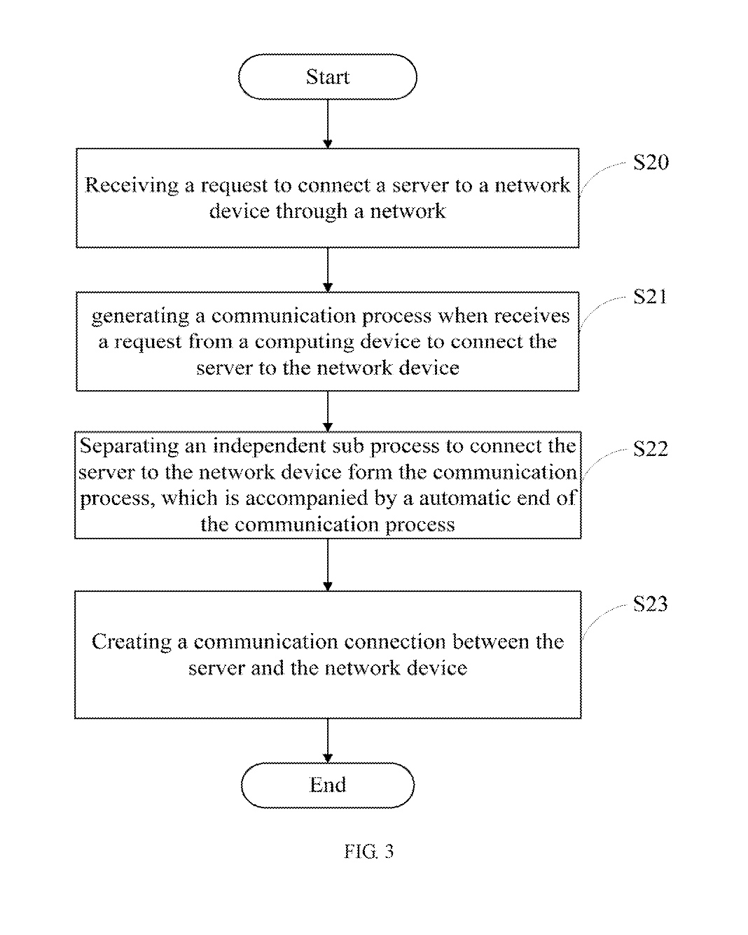

FIG. 2 is a block diagram of one embodiment of function modules of the communication connecting system 10. In the embodiment, the communication connecting system 10 may include a trigger module 100, a separation module 102, and a connecting module 104. The functions of the function modules 100-104 are illustrated in FIG. 3 and described below.

FIG. 3 illustrates a flowchart of one embodiment of the method for connecting the network device 3 to the server 2 of FIG. 1. Depending on the embodiment, additional steps may be added, others removed, and the ordering of the steps may be changed.

In step S20, the trigger module 100 receives a request to connect the server 2 to the network device 3 through the network 4. In the embodiment, the computing device 1 may send the said request to the server using a browser of the computing device 1.

In step S21, the trigger module 100 generates a communication process to connect the server 2 to the network device 3 when the request is received from the computing device 1. In the embodiment, the communication process carries necessary PHP modules (The PHP modules refer to logics or collections of software instructions written in the programming language PHP) to connect the server 2 to the network device 3, and also PHP modules, which is not necessary to connect the server 2 to the network device 3, which wastes memory of the server 2.

In step S22, a separation module 102 separates an independent sub process from the communication process by calling instructions of an operating system of the server 2 through a command-line interface (CLI), which is accompanied by an automatic end of the communication process. Because the communication process is ended, a new communication process can be generated by another request to connect the server 2 to another network device. The independent sub process is a special handler that is used to connect the server 2 to the network device 3. The independent sub process only carries the PHP modules to connect the server 2 to the network device 3. In the embodiment, the independent sub process may be separated form the communication process by calling an instruction of “nohup” of LINUX operating system or by calling an instruction of “start” and a parameter of “/b” of WINDOWS operating system.

In step S23, the connecting module 104 creates a communication connection between the server 2 and the network device 3. In the embodiment, the network device may be an IP camera, because different kinds of IP cameras are adapted to different communication protocols, so the connecting module 104 creates a communication connection between the server 2 and the network device 3 by means of HTTP Multi-Part.

Although certain embodiments of the present disclosure have been specifically described, the present disclosure is not to be construed as being limited thereto. Various changes or modifications may be made to the present disclosure without departing from the scope and spirit of the present disclosure.

What is claimed is:

1. A server electronically connected to a computing device through a network, the server comprising:
a storage device;
at least one processor; and
one or more programs being stored in the storage device and executed by the at least one processor, the one or more programs comprising:
a trigger module that generates a communication process when the trigger module receives a request to connect the server to a network device from the computing device, the communication process including an independent sub process, wherein the independent sub process connects the server to the network device and is accompanied by an automatic end of the communication process;
a separation module that separates the independent sub process from the communication process;
a connecting module that creates a communication connection between the server and the network device.

2. The server according to claim 1, wherein the separation module separates the independent sub process form the communication process by calling instructions of an operating system of the server through a command-line interface (CLI).

3. The server according to claim 1, wherein the request is sent by a browser of the computing device.

4. The server according to claim 1, wherein the server connects to the computing device through a wired network or a wireless network.

5. A method for connecting a server to a network device, the method comprising:
generating a communication process to connect the server to the network device, the communication process including an independent sub process, wherein the independent sub process connects the server to the network device and is accompanied by an automatic end of the communication process;
separating an independent sub process form the communication process;
creating a communication connection between the server and the network device.

6. The method according to claim 5, further comprising:
separating the independent sub process to connect to the network device form the communication process by calling instructions of an operating system of the server through a command-line interface (CLI).

7. The method according to claim 5, wherein the server connects to the computing device through a wired network or a wireless network.

8. The method according to claim 5, wherein the request to connect to the network device is sent by a browser of the computing device.

9. A non-transitory computer-readable storage medium having stored thereon instructions capable of being executed by a processor of a server, causes the processor to perform a method for connecting the server to a network device, the method comprising:
generating a communication process to connect the server to the network device, the communication process including an independent sub process, wherein the independent sub process connects the server to the network device and is accompanied by an automatic end of the communication process;
separating an independent sub process form the communication process;
creating a communication connection between the server and the network device.

10. The storage medium according to claim 9, wherein the method further comprising:
separating the independent sub process to connect to the network device form the communication process by calling instructions of an operating system of the server through a command-line interface (CLI).

11. The storage medium according to claim 9, wherein the server connects to the computing device through a wired network or a wireless network.

12. The storage medium according to claim 9, wherein the request to connect to the network device is sent by a browser of the computing device.
